(19) United States
(12) Patent Application Publication
(10) Pub. No.: US 2004/0239507 A1
(43) Pub. Date: Dec. 2, 2004

(54) Method and apparatus for perimeter detection

(76) Inventors: Anton M. Neary, Keene, NH (US); Stephen T. Neary, Spofford, NH (US)

Correspondence Address: Jeffrey B. Powers, Wolf, Greenfield & Sacks, P.C., 600 Atlantic Avenue, Boston, MA, 02210, US

(21) Appl. No.: 10/447,782

(22) Filed: May 29, 2003

(51) Int. Cl. G08B 23/00

(52) U.S. Cl. 340/573.4; 340/573.3

(57) ABSTRACT

A method and apparatus for detecting that an object has crossed a boundary, in which an electromagnetic field defines the boundary, and in which a signal is provided to an earthbound receiver. The boundary may be defined by a buried wire or a centrally located transmitter. The apparatus and method may be used with animate or inanimate objects. An indication that the object has crossed the boundary may alert a human or may result in a physical action such as closing a door.

### BACKGROUND OF INVENTION

1. Field of Invention

The present invention is directed to a method and apparatus for perimeter detection, and more particularly to a method and apparatus for perimeter detection employing an earthbound receiver.

2. Background

Various detection systems are known for detecting the presence of an animal or a human within a selected area. Such systems are commonly referred to as perimeter detection systems. One example of such a system for use with animals is commonly referred to as a wireless, pet containment system. In such systems, a wire is typically located in the ground, and the wire emits an electromagnetic field which defines a perimeter (i.e., a boundary) around an area. An animal to be contained in (or kept out of) the area wears a collar having a detector to detect the electromagnetic field, such that the locality of the animal may be determined relative to the wire. If the electromagnetic field is detected by the detector (i.e., the perimeter has been crossed), the collar delivers a shock and/or an audio alert to the animal.

Other perimeter detection systems, typically for use with humans, implement a global positioning system (GPS) including a satellite. Such systems are programmed with the coordinates defining a perimeter, and a human wears a transmitter which directs a signal to the satellite. By appropriate calculation, the GPS is able to determine whether the human is within the perimeter. Upon notification that the person has left the perimeter, an appropriate action may be taken. For example, the systems have been used with children or Altzheimer patients, to notify appropriate parties. Global positioning-based systems require sophisticated equipment, such as a satellite and a suitably programmed processor, and are typically accompanied by a periodic service charge for use of the GPS service.

### SUMMARY OF INVENTION

Aspects of the present system are directed to a perimeter detection system in which, upon detection that an object has left or entered an area defined by a perimeter, a signal is directly received by an earthbound receiver for signaling that the object has crossed a perimeter. Accordingly, embodiments of the invention may provide remote notification similar to a GPS system, while avoiding the difficulties and/or fees associated with satellite-based systems. It is to be appreciated that the object may be an animate object or an inanimate object. The term “earthbound receiver” is defined herein to mean any receiver directly or indirectly contacting the Earth. For example, an earthbound receiver may be attached to a pole secured in the ground, resting on a kitchen countertop, attached to human being, or in an automobile. The phrase “to directly receive a signal” is defined herein to mean at least a portion of the signal is received without reflection or retransmission (e.g., by a satellite).

A first aspect of the invention is directed to a perimeter detection system for determining the locality of an object, comprising: a first transmitter configured to provide an electromagnetic field; a transceiver adapted to detect the electromagnetic field and generate a signal in response to detection of the electromagnetic field; and an earthbound receiver configured to directly receive the signal and to provide an output in response to detection of the signal, whereby the locality of the object may be determined relative to the first transmitter. The term “locality” is defined herein to mean a location relative to a feature (e.g., an arbitrarily shaped perimeter). It is to be appreciated that, in most applications, a locality will not correspond to a single, specific point but will form a locus of points.

In some embodiments, the first transmitter is comprised of a driver and a wire, the wire being contoured to define the perimeter. The wire may be buried in the ground. Optionally, the wire may be formed into a plurality of loops. In some embodiments, the first transmitter is centrally located to the perimeter. In some embodiments, the transceiver may be comprised of a receiver and a second transmitter, the receiver being adapted to detect the electromagnetic field and communicate with the second transmitter, and the second transmitter being adapted to transmit the signal in response to the communication. The receiver and second transmitter may be separate portions of a single circuit. The object may be an inanimate object or an animate object. The electromagnetic field may be modulated. The signal may be comprised of at least one edge. In some embodiments, the transceiver includes at least one of an indicator adapted to provide at least one of a visual indication, an audio indication and a tactile indication in response to detection of the electromagnetic field. The perimeter detection system may further comprise an indicator adapted to receive the output and produce at least one of a visual indication, an audio indication and a tactile indication, and the indicator may be co-located with the earthbound receiver.

Another aspect of the invention is directed to a perimeter detection system for determining the locality of an object, comprising: a first transmitter configured to provide an electromagnetic field; a transceiver configured to detect the electromagnetic field and generate a signal in response to detection of the electromagnetic field; and an earthbound receiver means for directly receiving the signal and to provide an output in response to receiving the signal, whereby the locality of the object is determined relative to the first transmitter.

Still another aspect of the invention is directed to a theft deterrent system, comprising: a first transmitter buried in a yard and configured to provide an electromagnetic field; a transceiver connected to an object and detect the electromagnetic field and generate a signal in response to detection of the electromagnetic field; and an earthbound receiver configured to directly receive the signal and to provide an output in response to detection of the signal, whereby the locality of the object may be determined relative to the first transmitter. In some embodiments the transceiver is concealed on the object.

Yet another aspect of the invention is directed to a method of detecting that an object has crossed a perimeter, comprising the steps of: providing an electromagnetic field; detecting the electromagnetic field; generating a signal in response to detecting the electromagnetic field; directly receiving the signal with an earthbound receiver; and providing an output in response to receiving the second signal, whereby the locality of the object is determined relative to the first transmitter. The object may be an inanimate object or an animate object. Optionally, the method may further comprise the step of modulating the electromagnetic field. Additionally, the method may further comprise the step of providing at least one of a visual indication, an audio indication, and a tactile indication

Still another aspect of the invention is directed to a perimeter detection system having a plurality of earthbound receivers. In some embodiments, the receivers are in communication with one another or are in communication with a processor so as to be able to calculate the location of an object. In some embodiments, the location is determined using a triangulation technique, for example, using the time necessary for a signal from a transceiver to reach two or more of the earthbound receivers. In some embodiments, an a priori knowledge of the boundary (e.g., by the processor) is used as a part of the calculation to determine the location of the object. Multiple boundaries may be provided, for example, using multiple loops of wire to cover an area. A display may be used to illustrate the calculated location of the object.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic illustration of an exemplary embodiment of a perimeter detection system for determining the locality of an object according to some aspects of the present invention;

FIG. 2 is a schematic illustration of another exemplary embodiment of a perimeter detection system for determining the locality of an object according to some aspects of the present invention; and

FIG. 3 is a schematic illustration of yet another embodiment of a perimeter detection system according to some aspects of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

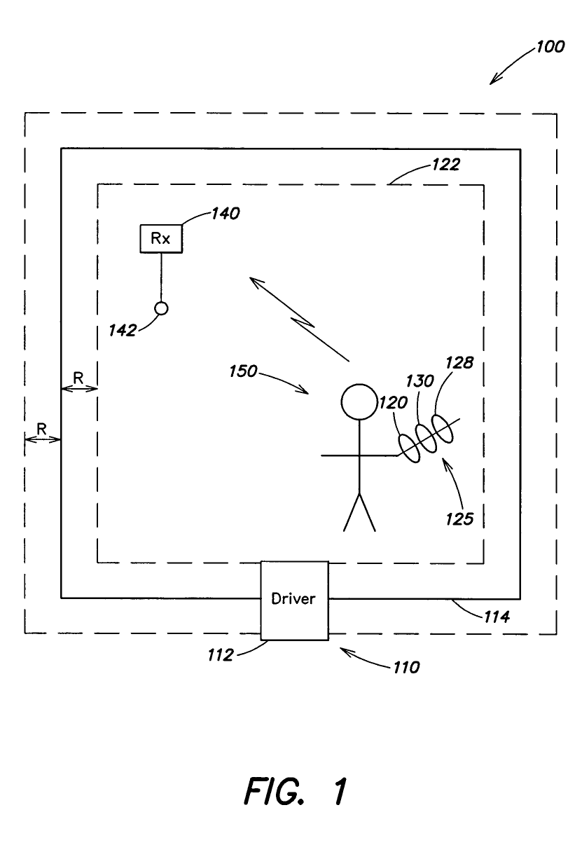

FIG. 1 is a schematic illustration of an exemplary embodiment of a perimeter detection system 100 for determining the locality of an object 150 according to some aspects of the present invention. System 100 includes a boundary transmitter 110, a transceiver 125, and an earthbound receiver 140. While object 150 is illustrated as a human, object 150 may be any suitable animate or inanimate object. Animate objects include both animals and humans, and inanimate objects include any suitable inanimate object. In some embodiments, inanimate object detection may be used to deter or prevent theft or removal of the object from a defined boundary. For example, the object may be a car, a boat, or a television. In some embodiments, the object may be borrowed or rented equipment, for example a shopping cart, a baby stroller, that is to be kept inside or outside of a perimeter.

In the illustrated embodiment, boundary transmitter 110 includes a driver 112 and wire 114 contoured to the boundary. Boundary transmitter 110 produces an electromagnetic field that may be used to define a perimeter 122 a distance R from wire 114. One of ordinary skill in the art would understand that the strength of the current in wire 114 determines the strength of the electromagnetic field around the wire, and that the field strength decreases as a function of distance from the wire. Additionally, the radius R and the corresponding boundary are determined by the electromagnetic field strength and a transceiver, detection threshold.

Boundary transmitter 10 may be any suitable transmitter capable of producing an electromagnetic field to define a perimeter. The electromagnetic field may be any field capable of detection by transceiver 125. For example, the electromagnetic field may be a static field or may have a periodic modulation (e.g., a sine wave, or a square wave) or a non-periodic modulation.

Driver 112 may be any suitable driver capable of inducing a current in wire 114 so as to produce an electromagnetic field to define perimeter 122. In some embodiments, driver 112 induces a current having a relatively low power and low modulation frequency. For example, driver 112 may operate at 12V and produce a current of 500 mA having a modulation frequency of 8.6 kHz.

In some embodiments, driver 112 is provided with an apparatus that allows for selection of the strength of the current in wire 114. Typical values of radius R range from 1-20 feet. However, the invention is not so limited and any radius R may be selected. Driver 112 may be powered by any conventional power source (not shown), for example, the power source may be a battery or a conventional wall outlet.

Wire 114 may be any suitable conductor capable of producing an electromagnetic field as described above. For example, the wire may be made of copper or another suitable material. The wire may have a single strand or multiple strands, and may have any suitable gauge (e.g., 12, 14, or 16). As one of ordinary skill in the art would understand, for a selected length of wire, the gauge, strand design, and selected material contribute to the wire inductance L_{wire}. In some embodiments, driver 112 is equipped with a variable output capacitance C. The selected capacitance combines with the inductance of wire 114 to produce a suitable time constant to facilitate production of the current in wire 114. One example of such a variable capacitance is described in U.S. Pat. No. 5,272,466, titled “Method and Apparatus for Defining a Perimeter.”

Typically wire 114 is buried (e.g., 1-3 inches below ground). However, the invention is not so limited and in some embodiments, the wire may be above ground. For example, wire 114 may be attached to a picket fence. In instances when a perimeter detection system is installed during the winter, the wire may be maintained above ground due to presence of snow and/or frozen ground and may, during subsequent warmer weather, be installed below ground.

Preferably, the wire has a durability suited to withstand the relevant environmental conditions for a desired duration. For example, in the case of wires to be buried, the wire may be selected to last 20-90 years in a buried state. In some embodiments, boundary transmitter 110 is equipped with an alarm to indicate that wire 114 has broken. For example, in response to a detected break in wire 114, an appropriate visual, tactile and/or audio indication may occur. A broken wire may be determined using any conventional technique (e.g., by monitoring resistance of the wire).

Although wire 114 is illustrated as having a single loop, wire 114 may be configured to have a plurality loops by twisting wire 114 using conventional wire twisting techniques to cancel the electromagnetic field in the region(s) between the plurality of loops. For example, a first loop may surround a yard and a second loop may surround a swimming pool or a garden, each loop forming a distinct boundary separated from one another by a length of twisted wire. Alternatively, loops may be formed using additional wires that are in parallel with wire 114 (i.e., the additional wires transmit currents from a common output of driver 112) or are independent of wire 114 (i.e., they transmit a current from an independent output of driver 112 or transmit current from a second driver).

Transceiver 125 may be any suitable device or combination of devices capable of detecting the electromagnetic field provided by boundary transmitter 110 and generating a signal in response to detection of the electromagnetic field. For example, transceiver 125 may include a receiver 120 in communication with a transmitter 130, such that when receiver 120 detects the electromagnetic field, it communicates to transmitter 130 that the transmitter is to transmit a signal. In some embodiments, transmitter 130 and receiver 120 are portions of a single, appropriately configured transceiver circuit. In embodiments in which receiver 120 and transmitter 130 are separate devices, they may be maintained in a single housing or may be in separate housings both attached to object 150.

For example, the signal produced by transceiver 125 may be any suitable electromagnetic signal, and may comprise an edge, a pulse (i.e., two edges), a series of pulses or a sinusoid. The signal may be analog or digital. In some embodiments, the signal will be modulated at a different frequency than the field which defines the perimeter. For example, the field may be modulated at a frequency equal to 8.6 kHz, and the signal may be modulated at a frequency equal to 303 MHz. Alternatively, the signal and the field may be modulated at a common frequency and distinguished by appropriate coding. The signal may be sonic.

In some embodiments, it is preferable that transceiver 125 be capable of detecting an electromagnetic field having a low strength, thereby reducing the power used by boundary transmitter 110 to generate the electromagnetic field. Depending on the electromagnetic field produced by boundary transmitter 110, transceiver 125 may be adapted to detect a digital or an analog signal. Receiver 120 may produce a digital signal output or an analog signal output in response to a detected field. In most applications, transceiver 125 is selected to have a light weight and a small size. Typically, transceiver 125 operates using a battery power source. It is to be appreciated that upon detecting the electromagnetic field, the locality of the object may be determined relative to wire 114 within a distance equal to radius R.

Any suitable technique may be used to attach transceiver 125 to object 150. The technique used is typically selected based on the nature of object 150 and the function that perimeter detection system 100 is to perform. For example, in applications where transceiver 125 is attached to a human, transceiver 125 may be adapted to attach to a wrist or belt; and in applications where transceiver 125 is attached to an animal, transceiver 125 may be adapted to attach to an animal collar. In applications where the transceiver is used on inanimate objects, it may be desirable to conceal the transceiver on the object (e.g., by camouflage, and/or attachment to an interior surface of the object) to avoid the transceiver from being seen or removed. In other applications where the transceiver is used on inanimate objects, it may be desirable that transmission 125 be attached to object 150 in a conspicuous location.

In some embodiments, transceiver 125 may include an indicator 128 to produce a visual, audio and/or tactile indication local to object 150, in response to detecting the electromagnetic field. In some embodiments, transceiver 125 provides an indication of the strength of the electromagnetic field detected by controlling indicator 128 such that the indicator provides an output proportional to the field strength. Additionally, the visual, audio and tactile indicators may be used in succession. For example, at a relatively low field strength a visual indicator may be activated, and as the field strength grows the visual indicator may get brighter, and at still higher field strength the tactile indicator may be activated.

Earthbound receiver 140 is configured to directly receive the signal from transceiver 125 and to provide an output in response to the signal. Earthbound receiver 140 may be any suitable receiver for detecting the signal, and may be located in any suitable location. The earthbound receiver may be located within a loop formed by wire 114, as illustrated in FIG. 1, or may be located outside of the loop. The output may include any electrical or electromagnetic output generated in response to detection of the signal. In some embodiments, the output is communicated to an indicator 142 which provides an audio, visual, and/or tactile indication.

Indicator 142 may be co-located with earthbound receiver 140 or may be located in a distinct location from the earthbound receiver (e.g., the earthbound receiver may be outside of a building and the indicator may be located on a desk inside the building). For example, indicator 142 may be located in any appropriate location to alert a human that the object has left the confines of the perimeter. In some embodiments, indicator 142 may alert a nurse that a patient has left a building or hospital grounds, or may alert a homeowner that his car or boat has left boundaries of his property. In other embodiments, the output may directly or indirectly cause a door to be closed, a phone to be dialed, a strobe to flash, a fire alarm to sound, or a signal to be sent to another transmitter.

Although the discussion above illustrated that a perimeter detection system may be used to determine whether an object is being maintained within a perimeter, it is to be appreciated that in some embodiments, a perimeter detection system may be use to determine whether an object is maintained outside of the perimeter.

A perimeter detection system in accordance with the present invention may be equipped with additional features. For example, additional features may comprise a back-up power supply for providing power to one or more components of the system in the event that the main power source is inoperable, lightening protection (e.g., one or more fuses), and/or power-surge protection.

As one of ordinary skill in the art would understand, transmitter components (e.g., transmitter 110, transceiver 125, and receiver 140) may be required to comply with Federal Communication Commission (FCC) regulations. For example, the duration of a given field or signal may be regulated, depending on the nature of the application that the perimeter detection system is to perform.

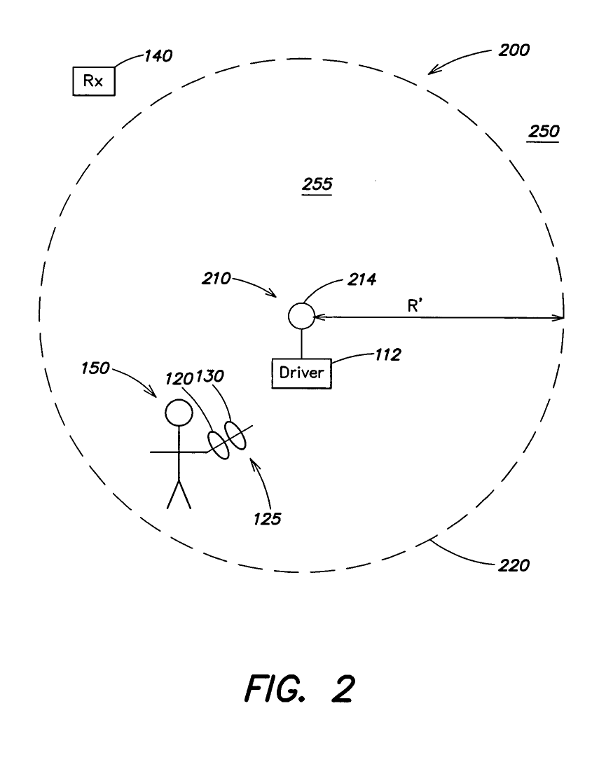

In some embodiments, transceiver 125 may transmit a continuous or continual signal to earthbound receiver 140 if the transceiver is in a location where it does not detect an electromagnetic field from transmitter 210 (e.g., as illustrated in FIG. 1, a distance greater than radius R from wire 114, either inside or outside of the wire loop). In other embodiments, transceiver 125 may transmit a continuous or continual signal to earthbound receiver 140 if the transceiver 125 is in a location (e.g., region 255) where it does detect an electromagnetic field from transmitter 210 (see FIG. 2). The term “continual signal” is defined herein to mean a signal that is repeated at a selected frequency. It is to be understood that a continual signal may include intervals during which the transceiver is powered-off, for example, to meet an FCC requirement or to conserve battery power.

In still other embodiments, transceiver 125 may transmit a signal to earthbound receiver 140 only upon a transition between a location where it detects an electromagnetic field from transmitter 110 to (and/or from) a location where it does not detect an electromagnetic field from transmitter 110. It is to be understood that the expression “does not detect an electromagnetic field” includes instances where the field is below a selected strength threshold, and in addition to instances where the field is non-existent.

While perimeter detection system 100 was discussed with reference to a system having a single transceiver 125, it is to be appreciated that a plurality of objects 150, each having a transceiver 125 may be used. An output from one of the transceivers may uniquely identify a transceiver. For example, the outputs of the various transceivers may occur at unique frequencies (or the outputs may be identified by distinct modulation patterns of a single frequency), and receiver 140 may be adapted to receive the distinct frequencies (or modulation patterns). A plurality of indicators 142, each corresponding to a selected transceiver, may provide distinguishable outputs in response to detection of a corresponding transceiver output, such that the locality of each of the plurality of objects can be detected relative to boundary 122.

FIG. 2 is a schematic illustration of another exemplary embodiment of a perimeter detection system 200 for determining the locality of object 150 according to some aspects of the present invention. System 200 includes a transceiver 125, and an earthbound receiver 140 and operates similar to system 100 in FIG. 1 except that boundary 220 is determined by a centrally located boundary transmitter 210 which emits an electromagnetic field to define boundary 220 at a distance R′ from boundary transmitter 210. The term “centrally located transmitter” is defined herein to mean substantially in the center of boundary 220, to within the sensitivity of receiver 120, and discounting any obstruction that may influence or block the transmission of the electromagnetic field from transmitter 210.

Although receiver 140 is illustrated as being outside of boundary 220, receiver 140 may be located inside of boundary 140. In some embodiments, driver 112, and emitter 214 of transmitter 214 and receiver 140 may be co-located and may be enclosed in a single housing.

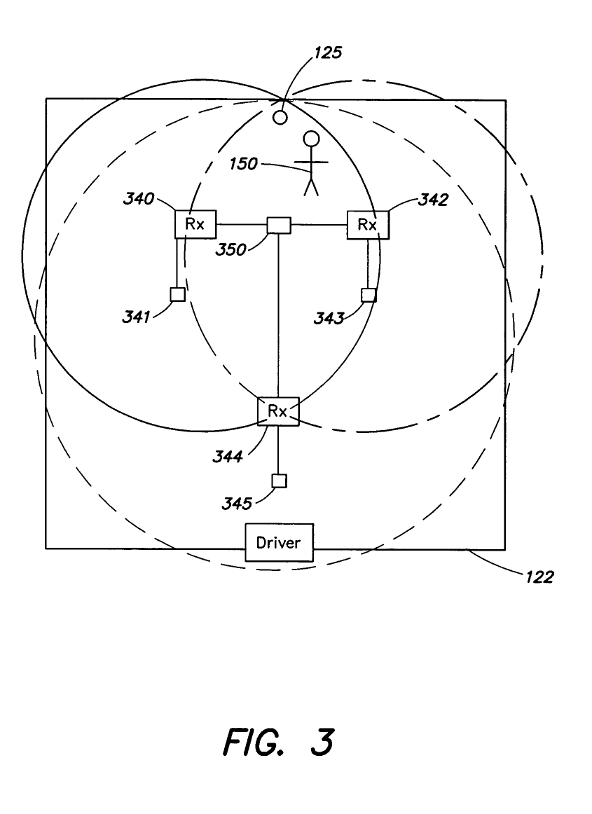

FIG. 3 is a schematic illustration of yet another embodiment of a perimeter detection system according to some aspects of the invention. Although the embodiments discussed above with reference to FIGS. 1 and 2 were discussed as having a single earthbound receivers 140, the embodiment illustrated in FIG. 3 has three receivers 340, 342, and 344. It is to be appreciated that such embodiments enable a signal produced by transceiver 125 (i.e., in response to detection of the electromagnetic field defining perimeter 122) to be detected in separate locations (e.g., in different buildings or different rooms of a single building). The receivers 340, 342 and 344 may be connected to indicators 341, 343, and 345, respectively.

In some embodiments, receivers 340, 342, and 344 simply provide control of an indicator; however, the multiple receivers may be in communication with one another or may all be in communication with a processor 350, such that based on the signals received by receivers 340, 342, and 344, not only is it determined that object 150 crossed the boundary at an arbitrary perimeter location, but a more precise location may be identified. For example, if a signal is radiated from transceiver 125 upon detecting perimeter 122 (i.e., the electromagnetic field), the time necessary for the signal to reach each of receivers 340, 342, and 344 may be used to calculate the location of object 150. Any suitable technique for determining the location of the object may be used (e.g., triangulation based on the time needed for the signal from transceiver 125 to reach each of the earthbound receivers). The location information in addition to the knowledge that the object reached the perimeter, may be used to determine a precise location of the object, rather than simply determining a locality (i.e., an arbitrary location about the perimeter.

While the embodiment illustrated in FIG. 3 has three receivers, in some embodiments only two receivers are present. It is to be appreciated that in such embodiments, the location of perimeter 122 relative to the two receivers may be known a priori by processor 350, and used in combination with information from the receivers to determine the location of object 150.

Additionally, while only one perimeter 122 is illustrated, any number of additional perimeters may be identified (e.g., by using two buried wires (not shown) or by using a threshold detection of an electromagnetic field from a single wire). In embodiments using multiple wires, wires may form concentric loops, may form rows or may be configured in any other suitable pattern. The multiple wires may produce electromagnetic fields that are distinguishable by transceiver 125 (e.g., the electromagnetic fields may be distinguished based on wavelength of the radiation forming the electromagnetic or pulsing of the radiation forming the electromagnetic field). In some embodiments, the signal produced by transceiver 125 depends on the electromagnetic field detected (i.e., depending on which wire produces the field).

Accordingly, the signal produced may be used, in combination with the location determination techniques described above (e.g., triangulation) to determine the location of object 150. In some embodiments such techniques may be used to detect the object within a complete area. It is to be appreciated that the area may be broken in discrete regions depending on how closely space the wires are. In some embodiments, processor 350 includes a display and the location of object is illustrated as it is determined.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A perimeter detection system for determining the locality of an object, comprising:
a first transmitter configured to provide an electromagnetic field, the field defining a perimeter;
a transceiver adapted to detect the electromagnetic field and generate a signal in response to detection of the electromagnetic field; and
an earthbound receiver configured to directly receive the signal and to provide an output in response to detection of the signal, whereby the locality of the object may be determined relative to the first transmitter.

2. The system of claim 1, wherein the first transmitter is comprised of a driver and a wire, the wire being contoured to define the perimeter.

3. The system of claim 2, wherein the wire is buried in the ground.

4. The system of claim 2, wherein the wire forms a plurality of loops.

5. The system of claim 1, wherein the first transmitter is centrally located to the perimeter.

6. The system of claim 1, wherein the transceiver is comprised of a receiver and a second transmitter, the receiver being adapted to detect the electromagnetic field and communicate with the second transmitter, and the second transmitter being adapted to transmit the signal in response to the communication.

7. The system of claim 6, wherein the receiver and second transmitter are separate portions of a single circuit.

8. The system of claim 1, wherein the object is an inanimate object.

9. The system of claim 1, wherein the object is an animate object.

10. The system of claim 1, wherein the electromagnetic field is modulated.

11. The system of claim 1, wherein the signal is comprised of at least one edge.

12. The system of claim 1, wherein the transceiver includes at least one of an indicator adapted to provide at least one of a visual indication, an audio indication and a tactile indication in response to detection of the electromagnetic field.

13. The system of claim 1, further comprising an indicator adapted to receive the output and produce at least one of a visual indication, an audio indication and a tactile indication.

14. The system of claim 13, wherein the indicator is co-located with the earthbound receiver.

15. A perimeter detection system for determining the locality of an object, comprising:
a first transmitter configured to provide an electromagnetic field;
a transceiver configured to detect the electromagnetic field and generate a signal in response to detection of the electromagnetic field; and
an earthbound receiver means for directly receiving the signal and to provide an output in response to receiving the signal, whereby the locality of the object is determined relative to the first transmitter.

16. A theft deterrent system, comprising:
a first transmitter buried in a yard and configured to provide an electromagnetic field;
a transceiver connected to an object to detect the electromagnetic field and generate a signal in response to detection of the electromagnetic field; and
an earthbound receiver configured to directly receive the signal and to provide an output in response to detection of the signal, whereby the locality of the object may be determined relative to the first transmitter.

17. The theft deterrent system of claim 16, wherein the transceiver is concealed on the object.

18. A method of detecting that an object has crossed a perimeter, comprising the steps of:
providing an electromagnetic field;
detecting the electromagnetic field;
generating a signal in response to detecting the electromagnetic field;
directly receiving the signal with an earthbound receiver; and
providing an output in response to receiving the second signal, whereby the locality of the object is determined relative to the first transmitter.

19. The method of claim 18, wherein the object is an inanimate object.

20. The method of claim 18, wherein the object is an animate object.

21. The method of claim 18, further comprising the step of modulating the electromagnetic field.

22. The method of claim 17, further comprising the step of providing at least one of a visual indication, an audio indication, and a tactile indication.
